(19) United States
(12) Patent Application Publication
(10) Pub. No.: US 2013/0335528 A1
(43) Pub. Date: Dec. 19, 2013

(54) IMAGING DEVICE CAPABLE OF PRODUCING THREE DIMENSIONAL REPRESENTATIONS AND METHODS OF USE

(71) Applicant: Board of Regents of the University of Texas System, Austin, TX (US)

(72) Inventors: Sriram Vishwanath, Austin, TX (US); Chris Slaughter, Austin, TX (US)

(21) Appl. No.: 13/895,030

(22) Filed: May 15, 2013

Related U.S. Application Data
(60) Provisional application No. 61/646,997, filed on May 15, 2012.

(51) Int. Cl. H04N 13/02

(52) U.S. Cl. CPC H04N 13/026
USPC 348/46

(57) ABSTRACT

Described herein is a system and method to create a 3D representation of an observed scene by combining multiple views from a moving image capture device. The output is a point cloud or a mesh model. Models can be captured at arbitrary scales varying from small objects to entire buildings. The visual fidelity of produced models is comparable to that of a photograph when rendered using conventional graphics rendering. Despite offering fine-scale accuracies, the mapping results are globally consistent, even at large scales.

### PRIORITY CLAIM

This application claims the benefit of U.S. Provisional Application No. 61/646,997 filed on May 15, 2012.

### BACKGROUND OF THE INVENTION

1. Field of the Invention

The invention generally relates to imaging devices capable of producing three dimensional representations.

2. Description of the Relevant Art

Three dimensional representations are used represent any three dimensional object (animate or living). A three dimensional representation, as used herein, is a computer generated image that represents a three dimensional object. A three dimensional representation may be a solid representation or a shell representation. Most three dimensional representations are formed from a collection of points that are mapped out in three dimensional space. Computers that are used to visualize three dimensional representations allow the three dimensional representation to be manipulated freely within the three dimensional space defined by the computing environment.

Three dimensional representations are used in a number of industries including engineering, the movie industry, video games, the medical industry, chemistry, architecture, and earth science. The construction of three dimensional representations, however, may be a time consuming costly process. This can be especially true if the three dimensional representation being prepared is a model of an actual environment, object, or living subject. It is therefore desirable to have a system of preparing three dimensional representations in an efficient, cost effective manner.

### SUMMARY OF THE INVENTION

In an embodiment, an imaging device includes: a body; an image capture device coupled to the body, wherein the image capture device collects an image of a target or environment in a field of view and a distance from the image capture device to one or more features of the target or environment; a processor coupled to the image capture device and disposed in the body, wherein the processor receives data from the image capture device and generates a three dimensional representation of the target or environment; and a display device, coupled to the processor and the body, wherein the three dimensional representation is displayed on the display device. The three dimensional representation of the target comprises color, shape and/or motion of the target.

The image capture device includes sensors capable of collecting color information of the target, grayscale information of the target, depth information of the target, range of features of the target from the imaging device, or combinations thereof. In one embodiment, the image capture device is a range camera. Exemplary range cameras include, but are not limited to, a structured light range camera and a lidar imaging device. The body includes a front surface and an opposing rear surface. In one embodiment, the image capture device is coupled to the front surface of the body, and the display screen is coupled to the rear surface of the body. The display screen may be an LCD screen.

The processor of the imaging device is capable of generating the three dimensional representation of the target substantially simultaneously as data is collected by the imaging device. The processor is also capable of displaying the generated three dimensional representation of the target substantially simultaneously as data is collected by the imaging device. In one embodiment, the processor provides a graphic user interface for the user, wherein the graphic user interface allows the user to operate the imaging device and manipulate the three dimensional representation.

The processor may be capable of capturing the motion of a target and producing a video of the target. In an embodiment, the processor is capable of capturing the motion of a living subject and converting the captured motion into a wireframe model which is capable of movement mimicking the captured motion.

A method of generating a multidimensional representation of an environment, includes: collecting images of an environment using an imaging device, the imaging device comprising: a body; an image capture device coupled to the body; a processor coupled to the image capture device and disposed in the body; and a display device, coupled to the processor and the body; collecting a distance from the image capture device to one or more regions of the environment; generating, using the processor, a three dimensional representation of the environment; and displaying the three dimensional representation of the environment on the display device.

In an embodiment, collecting image information and distance information of the environment is performed by panning the imaging device over the environment. In an embodiment, the method includes substantially simultaneously generating the three dimensional representation of the environment as the data is collected by the imaging device; and determining the position of the imaging device within the environment by comparing information collected by the imaging device to the generated three dimensional representation of the environment. The method also may include extending the generated three dimensional representation of the environment as the imaging device is moved to areas of the environment not previously captured. In an embodiment, the method includes refining the generated three dimensional representation of the environment when the imaging device is moved to a region of the environment that is a part of the generated three dimensional representation.

In an embodiment, a method of generating a multidimensional representation of a target, includes: collecting images of the target using an imaging device, the imaging device comprising: a body; an image capture device coupled to the body; a processor coupled to the image capture device and disposed in the body; and a display device, coupled to the processor and the body; collecting a distance from the image capture device to one or more regions of the target; generating, using the processor, a three dimensional representation of the target; and displaying the three dimensional representation of the target on the display device.

In an embodiment, the target is an object. The method includes producing a three dimensional representation of the object by collecting image information and distance information of the object as the image capture device is moved around the object. In another embodiment, the target is a living subject. The method includes producing a three dimensional representation of the living subject by collecting image information and distance information of the living subject as the image capture device is moved around the living subject. In an embodiment, the method includes substantially simultaneously generating the three dimensional representation of the target as the data is collected by the imaging device; and determining the position of the imaging device with respect to the target by comparing information collected by the imaging device to the generated three dimensional representation of the target. The method also includes extending the generated three dimensional representation of the target as the imaging device is moved around the target. In an embodiment, the method includes refining the generated three dimensional representation of the target when the imaging device is moved to a region of the target that is a part of the generated three dimensional representation.

In an embodiment, a method of capturing motion of a moving subject, includes: collecting images of the moving subject using an imaging device, the imaging device comprising: a body; an image capture device coupled to the body; a processor coupled to the image capture device and disposed in the body; and a display device, coupled to the processor and the body; collecting a distance from the image capture device to one or more regions of the moving subject; generating, using the processor, a video of the moving subject; generating, using the processor, a wireframe representation of the moving subject; and displaying the video of the moving subject on the display device, wherein the video comprises of the wireframe representation superimposed over images of the moving subject displayed in the video. In an embodiment, the imaging device is held in a substantially stationary position as the images and distance information of the moving subject is collected. In an alternate embodiment, the imaging device is moved around the moving subject as the images and distance information of the moving subject is collected. The wireframe representation, in an embodiment, is a three dimensional representation of the moving subject. In an embodiment, the method includes substantially simultaneously generating the wireframe representation of the target as the data is collected by the imaging device.

In an embodiment, a method of determining the geographical location of a mobile device, includes: collecting images of an environment using a mobile device, the mobile device comprising: a body; an image capture device coupled to the body; and a processor coupled to the image capture device and disposed in the body; collecting a distance from the image capture device to one or more regions of the environment; generating, using the processor, a three dimensional representation of the environment; and comparing the generated three dimensional representation of the environment to a graphical database comprising three dimensional representations of a plurality of environments at a plurality of known locations; determining the location of the mobile device based on the comparison of the three dimensional representation of the environment to environments in the graphical database. The mobile device may include a display screen. The method may include displaying the three dimensional representation of the environment on the display device; and displaying the location of the mobile device on a map image generated on the display device by the processor. The graphical database may be stored in the mobile device. The graphical database may be limited to an area where the mobile device is expected to be used.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1A is a front view of an imaging device;

FIG. 1B is a back view of an imaging device;

FIG. 2 is a schematic diagram of the electronic components of the imaging device;

FIG. 3 is schematic diagram of row vectors that represent a valid rigid-body motion;

FIG. 4 is a schematic diagram of a visualization of sparse subspace projection as basis-pursuit denoising; and

FIG. 5 is a schematic diagram of an image capture method.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

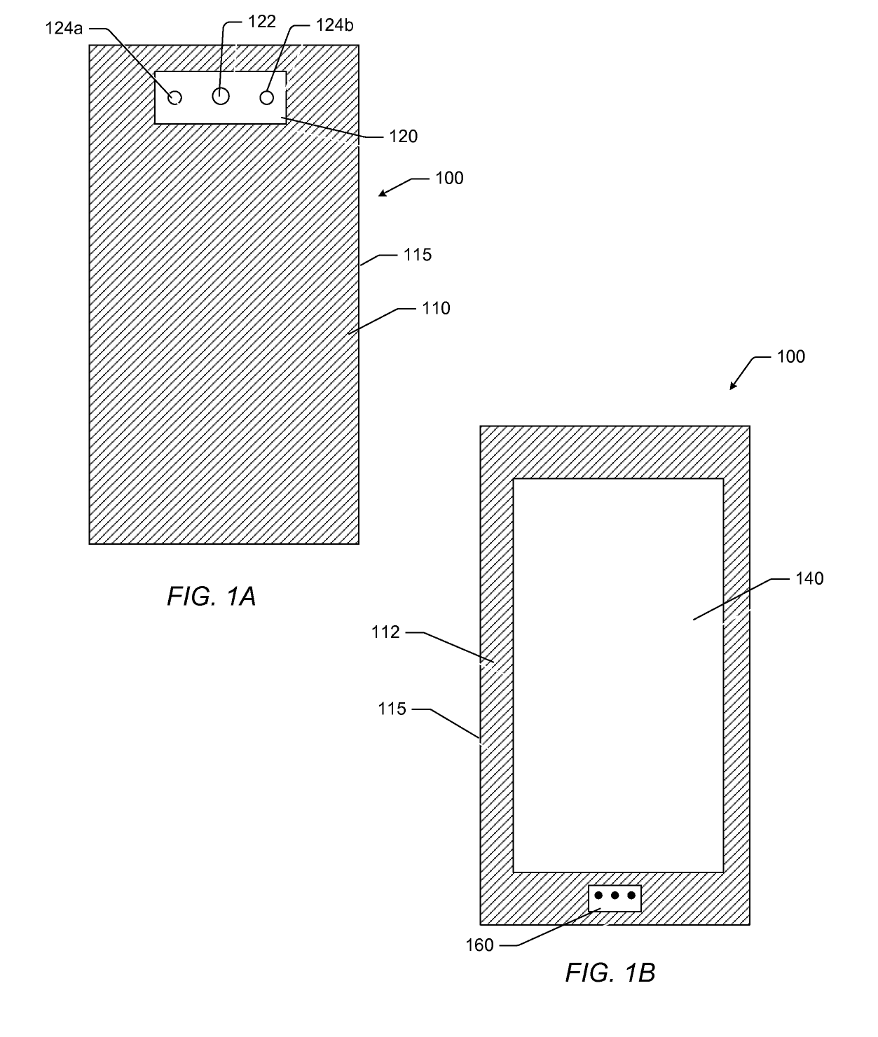

An embodiment of an imaging device 100 is depicted in FIGS. 1A and 1B. FIG. 1A depicts a front surface 110 of imaging device 100. FIG. 1B depicts a rear surface 112 of imaging device 100. Imaging device 100 includes a body 115 which holds the various components of the imaging device. Body 115 may be formed from any suitable material including polymers or metals.

Imaging device 100 includes one or more image capture devices 120. Image capture devices are coupled to body 115. Image capture devices may be disposed on an outer surface of body or within body 115. When disposed within body 115, the body may have a window formed on front surface, which allows light to pass through the body to image capture device 120. Image capture device 120 is capable of collecting an image of a target or environment in a field of view. The image captured may be a black and white image or a color image. The image capture device is also capable of determining a distance from the image capture device to one or more features of the target or environment. For example, image capture device 120 may include an RBG imaging component 122 and distance determination components 124a and 124b. Distance determination is typically performed using a transmitter 124a and a receiver 124b. A signal is sent from the transmitter 124a to the target being scanned and the signal is reflected from the target back to the receiver 124b.

Numerous types of image capture devices may be used. Generally, a suitable image capture device comprise sensors capable of collecting color information, grayscale information, depth information, distance of features of the target or environment from the imaging device, or combinations thereof. Image capture device generally provides a pixelated output that includes color information and/or grayscale information and a distance measurement associated with each pixel. This data can be used to generate a three dimensional representation of the target or environment.

Examples of suitable imaging devices include range cameras. A range camera produces an output that includes pixel values which correspond to the distance. Range cameras may be calibrated such that the pixel values can be given directly in physical units (e.g., meters). Range cameras may employ different techniques for the determination of distance values. Examples of techniques that may be used, include, but are not limited to: stereo triangulation, sheet of light triangulation, structured light, time-of-flight, interferometry, and coded aperture. In many techniques IR light or laser light (lidar cameras) is used for distance determinations. In one embodiment, the image capture device is a structured light range camera. Examples of structured light cameras and methods of manipulating the data received from such cameras are described in U.S. Pat. No. 7,433,024 to Garcia et al. and U.S. Published Patent Application Nos. 2009/0096783 to Shpunt et al. and 2010/0199228 to Latta et al., all of which are incorporated herein by reference.

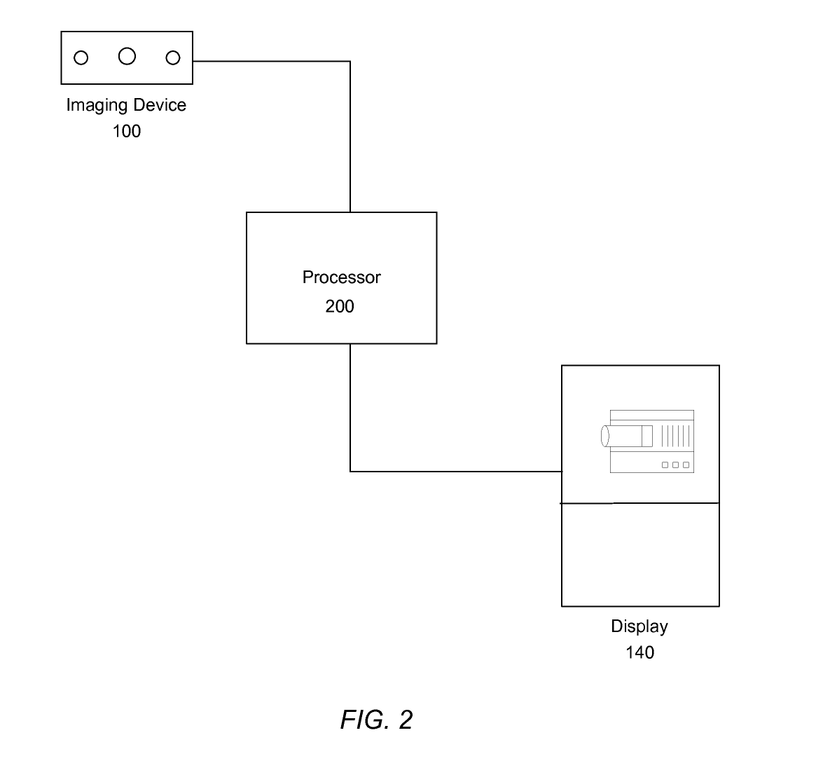

A schematic diagram of the electronic components of the imaging device is depicted in FIG. 2. Processor 200 is coupled to image capture device 120 and disposed in body 115 (not shown). Processor 200 receives data from image capture device 120 and generates a three dimensional representation of the target. The three dimensional representation of the target includes color, shape and motion of the target. In some embodiments the processor includes a central processing unit (“CPU”) and a graphics processing unit “GPU”. The processor uses both the CPU and the GPU to render graphical representations substantially simultaneously with the data collection. Traditional visualization algorithms are computationally very expensive, requiring considerable offline processing and back-end stitching before they present their output. In an embodiment, a processor may be used that uses high speed GPUs. The processor collects the data and generates a three dimensional point cloud. A point cloud is a set of data points in a coordinate system. A three dimensional point cloud is a set of data points in a three dimensional coordinate system. The three dimensional point cloud is converted to a rendered three dimensional representation which is displayed on display 140. The processor may include one or more software programs that are capable of rendering a three dimensional representation from a generated three dimensional point cloud.

In one embodiment, a three dimensional point cloud is prepared as the data is collected. The collected data is processed using processing algorithms; registration, alignment and tracking algorithms as well as a reconstruction algorithm to provide the user with a seamless and fully automated end-to-end real-time three dimensional representation. In one embodiment, the processor is designed for performing simultaneous localization and mapping to build the three dimensional representation. During simultaneous localization and mapping data is collected for the environment or object that is in the field of view of the image capture device. To create a fully rendered model of the environment or object it is necessary to move the imaging device around the environment or object to be sure that the entire environment or object is captured by the imaging device. In simultaneous localization and mapping, a three dimensional representation of the object is built as the object is captured by the imaging device. AS the image capture device is moved, additional data points outside the field of view of the previous images captured are captured. These additional points are added to initially to the generated three dimensional representation to create an updated three dimensional representation in real time.

In order to be able to create a three dimensional representation in real time, algorithmic techniques that enable a robust, real-time motion registration was developed. The algorithm first utilizes Robust PCA to initialize a low-rank shape representation of the rigid body. Robust PCA finds the global optimal solution of the initialization, while its complexity is comparable to singular value decomposition. In the online update stage, an algorithm is used for sparse subspace projection to sequentially project new feature observations onto the shape subspace. The lightweight update stage guarantees the real-time performance of the solution while maintaining good registration even when the image sequence is contaminated by noise, gross data corruption, outlying features, and missing data.

Rigid body motion registration (RBMR) is one of the fundamental problems in machine vision and robotics. Given a dynamic scene that contains a (dominant) rigid body object and a cluttered background, certain salient image feature points can be extracted and tracked with considerable accuracy across multiple image frames. The task of RBMR then involves identifying the image features that are associated only with the rigid-body object in the foreground and subsequently recovering its rigid-body transformation across multiple frames. Traditionally, RBMR has been mainly conducted in two dimensional image space, with the assumption of the camera projection model from simple orthographic projection to more realistic camera models such as paraperspective and affine. In problems such as RBMR, Structure from Motion (SfM), and motion segmentation, a fundamental observation is that a data matrix that contains the coordinates of tracked image features in column form can be factorized as a camera matrix that represents the motion and a shape matrix that represents the shape of the rigid body in the world coordinates. Furthermore, if the data are noise-free, then the feature vectors in the data matrix lie in a 4-D subspace, as the rank of the shape matrix in the world coordinates is at most four.

In practice, the RBMR problem can become more challenging if the tracked image features are perturbed by moderate noise, gross image corruption (e.g., when the features are occluded), and missing data (e.g., when the features leave the field of view). In robust statistics, it is well known that the optimal solution to recover a subspace model when the data is complete yet affected by Gaussian noise is singular value decomposition (SVD). Solving other image nuisances caused by gross measurement error corresponds to the problem of robust estimation of a low-dimensional subspace model in the presence of corruption and missing data.

In the case of outlier rejection, arguably the most popular robust model estimation algorithm in computer vision is Random Sample Consensus (RANSAC). In the context of RBMR, the standard procedure of RANSAC is to apply the iterative hypothesize-and-verify scheme on a frame-by-frame basis to recover rigid-body motion. In the context of dimensionality reduction, RANSAC can also be applied to recover low-dimensional subspace models, such as the above shape model in motion registration.

Nevertheless, the aforementioned solutions have two major drawbacks. In the case of missing data, methods such as Power Factorization or incremental SVD cannot guarantee the global convergence of the estimate. In the case of outlier rejection, the RANSAC procedure is known to be expensive to deploy in a real-time, online fashion, such as in the solutions for simultaneous localization and mapping (SLAM). Therefore, a better solution than the state of the art should provide provable global optimality to compensate missing data, image corruption, and erroneous feature tracks, and at the same time should be more efficient to recover rigid body motion from a video sequence in an online fashion.

In an embodiment, a solution to the problems of the prior algorithms is based on the emerging theory of Robust PCA (RPCA). In particular, RPCA provides a unified solution to estimating low-rank matrices in the cases of both missing data and random data corruption. The algorithm is guaranteed to converge to the global optimum if the ambient space dimension is sufficiently high. Compared to other existing solutions such as incremental SVD and RANSAC, the set of heuristic parameters one needs to tune is also minimal. Furthermore, convex optimization can be used to create very efficient numerical implementation of RPCA with the computational complexity comparable to that of classical SVD.

In an embodiment, online 3-D motion registration includes two steps. In the initialization step, RPCA is used to estimate a low-rank representation of the rigid-body motion within the first several image frames, which establishes a global shape model of the rigid body. In the online update step, we propose a sparse subspace projection method that projects new observations onto the low-dimensional shape model, simultaneously correcting possible sparse data corruption. The overall algorithm is called Sparse Online Low-rank projection and Outlier rejection (SOLO).

The algorithm for preparing real-time three dimensional representations includes a 3D tracking subsystem which identifies salient image features, and then tracks them frame by frame in image space. The features are then reprojected onto the camera coordinate system using depth measurements obtained from the image capture device. Over time, new features are extracted on periodic intervals to maintain a dense set over the image geometry. Each feature is tracked independently, and may be dropped once it leaves the field of view or produces spurious results (jumps) in camera space.

In one embodiment, a Kanade-Lucas-Tomasi feature tracker (KLT) may be used in the 3D tracking subsystem. A KLT tracker is extremely fast and can run in real time on a standard desktop computer. For KLT to work effectively, the extracted features should exhibit local saliency. To achieve this and produce a dense set of features over scenes, we use the Harris corner detector as well as a Difference of Gaussians (DoG) extractor. Only the lowest two levels of the DoG pyramid are used. This ensures that the features exhibit high local saliency in a small window and are spatially well-localized.

One implicit advantage of tracking features across multiple frames is that it permits the tracking data to be represented naturally as a matrix. Each (sample-indexed) row represents observations of multiple features in a single time step, while each column represents the observations of each feature over all frames. Overall, the tracking system uses simple, efficient algorithms that can track well-localized feature trajectories over multiple frames. Together with the registration algorithm, described below, the complete system allows real time three dimensional representations to be produced.

As a point of comparison, many existing SLAM front-ends employ feature extraction and matching on a frame-by-frame basis. This technique works quite well because RANSAC rejects misaligned features. However, they are subject to two major drawbacks. First, real time applications of extract-and-match techniques require hardware acceleration to run in real time. Second, they match features between frames in feature space, neglecting continuity of spatial observations of these features.

First, we shall formulate the 3D RBMR problem and introduce the notation we will use for this section. We denote x_{i;j}εR³ as the coordinates of feature j in the ith frame, where iε[1, . . . , F] and jε[1, . . . , m]. In the noise-free case, when the same jth feature is observed in two different frames 1 and i, its images satisfy a rigid-body constraint:

x_{i,j}=Rᵢx_{i,j}+Tᵢε [symbol] ³, (1)

where Rᵢε [symbol] ^{3×3} is a rotation matrix and Tᵢε [symbol] ^{3×1} is a 3-D translation. This relation can be also written in homogeneous coordinates as

$${x}_{i , j} = Π [ \begin{matrix}{R}_{i} & {T}_{i} \\ 0 & 1\end{matrix} ] [ \begin{matrix}{x}_{1 , j} \\ 1\end{matrix} ] ≐ Π {g}_{i} [ \begin{matrix}{x}_{1 , j} \\ 1\end{matrix} ] , \qquad ( 2 )$$

where Π=[I₃, 0]ε [symbol] ^{3×4} is a projection matrix.

In the noise-free case, since all the features in the ith frame satisfy the same rigid-body motion, one can stack the image coordinates of the same feature in the F frames in a long vector form, and then the collection of all the m features form a data matrix X, which can be written as the product of two rank-4 matrices:

$$X ≐ [ \begin{matrix}{x}_{1 , 1} & … & {x}_{1 , m} \\ ⋮ & … & ⋮ \\ {x}_{F , 1} & … & {x}_{F , m}\end{matrix} ] = [ \begin{matrix}Π {g}_{1} \\ ⋮ \\ Π {g}_{F}\end{matrix} ] [ \begin{matrix}{x}_{1 , 1} , & … , & {x}_{1 , m} \\ 1 , & … , & 1\end{matrix} ] ∈ {ℝ}^{3 F \times m} . \qquad ( 3 )$$

In particular, g₁=I₄ represents the identity matrix. It was observed that when F, m>>4, the rank of matrix X that represents a rigid-body motion in space is at most four, which is upper bounded by the rank of its two factor matrices in (3). In SfM, the first matrix on the right hand side of (3) is called a motion matrix M, while the second matrix is called a shape matrix S. Although (3) is not a unique rank-4 factorization of X, a canonical representation can be determined by imposing additional constraints on the shape of the object.

Lastly, for motion registration, if we denote the 3-D coordinates (e.g., under the world coordinates centered at the image capture device) of the first frame as: W₁=[x_{1,1}, . . . , x_{1,m}]ε [symbol] ^{3×m}, then the rigid body motion (Ri; Ti) of the features from the world coordinates to any ith frame satisfies the following constraint:

Wᵢ=[x_{i,1}, . . . ,x_{i,m}]=RᵢW₁+Tᵢ1^{T}. (4)

Using (4), the two transformations Rᵢ and Tᵢ can be recovered by the Orthogonal Procrustes (OP) method. More specifically, let μᵢεR³ be the mean vector of and denote \ddot{W}ᵢ as the centered feature coordinates after the mean is subtracted. Suppose the SVD of \ddot{W}ᵢ\ddot{W}ₗ^{T} gives rise to:

(U,Σ,V)=svd(\ddot{W}ᵢ\ddot{W}₁^{T}). (5)

Then the rotation matrix Ri=UV^{T}, and the translation Tᵢ=μᵢ−Rᵢμₗ.

In this embodiment, we consider an online solution to RBMR. Our goal is to maintain the estimation of a low-rank representation of X and its subsequent new observations Wᵢ with minimal computational complexity. In the rest of the section, we first discuss the initialization step to jump start the low-rank estimation of the initial observations X. Then we propose our solution to update the low-rank estimation in the presence of new observations in ith frame Wᵢ. Finally, applying our algorithm on real-world data may encounter additional nuisances such as new feature tracks entering the scene and missing data. After the summary of Algorithm 1, we will briefly show that the proposed solution can be easily extended to handle these additional conditions in an elegant way.

In the initialization step, a robust low-rank representation of X needs to be obtained in the presence of moderate Gaussian noise, data corruption, and outlying image features. The problem can be solved in closed form by Robust PCA. Here we model Xε [symbol] ^{n×m} as the sum of three components:

X=L₀+D₀+E₀, (6)

where L₀ is a rank-4 matrix that models the ground-truth distribution of the inlying rigid-body motion, D₀ is a Gaussian noise matrix that models the dense noise independently distributed on the X entries, and E₀ is a sparse error matrix that collects those nonzero coefficients at a sparse support set of corrupted data, outlying image features and bad tracks.

The matrix decomposition in (6) can be successfully solved by a principal component pursuit (PCP) program:

$${min}_{L , E} {‖ L ‖}_{*} + λ {‖ E ‖}_{1} subj . to {‖ X - L - E ‖}_{F} \leq δ , \qquad ( 7 )$$

where ∥•∥* denotes matrix nuclear norm, ∥•∥ₗ denotes entry-wise l₁-norm for both matrices and vectors, and λ is a regularization parameter that can be fixed as \sqrt{max(n,m)}. When the dimension of matrix X is sufficiently high and with some extra mild conditions on the coefficients of L₀ and E₀, with overwhelming probability, the global (approximate) solution of L₀ and E₀ can be recovered.

The key characteristics of the PCP algorithm are highlighted as follows: Firstly, the regularization parameter does not necessarily rely on the level of corruption in E₀, so long as their occurrences are bounded. Secondly, although the theory assumes the sparse error should be randomly distributed in X, the algorithm itself is surprisingly robust to both sparse random corruption and highly correlated outlying features as a small number of column vectors in X. Finally, although the original implementation of PCP is computationally intractable for real-time applications, its most recent implementation based on an augmented Lagrangian method (ALM) has significantly reduced its complexity. We thus adopted the ALM solver for Robust PCA, whose average run time is merely a small constant (in general smaller than 20) times the run time of SVD. In our online formulation of SOLO, this calculation only needs to be performed once in the initialization step.

Since the resulting low-rank matrix L may still contain entries of outlying features, an extra step needs to be taken to remove those outliers. In particular, one can calculate the l₀-norm of each column in E₀=[e₁, e₂, . . . , eₘ]. With respect to an outlier threshold τ, if le₁l₀>τ, then eᵢ represents dense corruption on the corresponding feature track and hence should be regarded as an outlier. Subsequently, the indices of the inliers define a support set I⊂[1, . . . , m]. Hence, we denote the cleaned low-rank data matrix after outlier rejection as

\hat{L}=L⁽¹⁾. (8)

Finally, we note that although in (7), L represents the optimal matrix solution with the lowest possible rank, due to additive noise and data corruption in the measurements, its rank may not necessarily be less than five. Therefore, to enforce the rank constraint in the RBMR problem and further obtain a representative of the shape matrices that span the 4-D subspace, an SVD is performed on \hat{L} to identify its right eigenspace:

(U,Σ,V)=svds(\hat{L},4), (9)

where V^{T}ε [symbol] ^{4×m} is then a representative of the rigid body's shape matrices.

A novel algorithm is used to project new observations Wᵢ from the ith frame onto the rigid-body shape subspace. This subspace is parameterized by the shape matrix V^{T} that we have estimated in the initialization step. Traditionally, a (least squares) subspace projection operator would project a (noisy) sample perpendicular to the surface of the subspace that it is close to, which only involves basic matrix-vector multiplication. However, in anticipation of continual random feature corruption during the course of feature tracking for RBMR, the projection must also be robust to sparse error corruption in Wᵢ. Hence, we contend that SOLO is a more appropriate yet still efficient algorithm to achieve online motion registration update.

Given the initialization \hat{L} and the inlier support set I, without loss of generality, we assume Wᵢ only contains those features in the support set I. As discussed in (3) and (9), matrix V^{T} from the SVD of \hat{L} is a representative of the class of all the shape matrices of the rigid body up to an ambiguity of 4-D rotation on the subspace. Therefore, the new observations Wᵢ of the same features should also lie on the same shape subspace. That is, let

Wᵢ=[w₁^{T};w₂^{T};w₃^{T}]

where each

w₁^{T}ε [symbol] ^{1×m}

is a row vector. Then

wⱼ^{T}=a^{T}V^{T} for some a^{T}ε [symbol] ^{1×4}. (10)

In the presence of sparse corruption, the row vector wᵢ^{T} is perturbed by a sparse vector e:

wⱼ^{T}=a^{T}V^{T}+e^{T}, where e^{T}ε [symbol] ^{1×m}. (11)

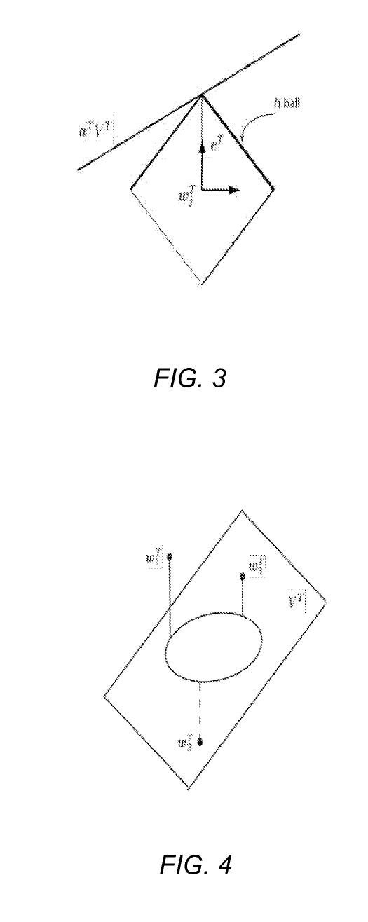

The sparse projection constraint (11) bears resemblance to basis-pursuit denoising (BPDN) in compressive sensing literature, as a sparse error perturbs a high-dimensional sample away from a low-dimensional subspace model. The standard procedure of BPDN using 4-minimization min) is illustrated in FIG. 3.

However, we notice that a BPDN-type solution via 4-min may not be the optimal solution to our problem. The reason is that the row vectors in W=[w₁^{T};w₂^{T};w₃^{T}] are not three arbitrary vectors in the 4D V^{T}. In fact, the three vectors must be projected onto a nonlinear manifold M embedded in the shape subspace V^{T}, and the span of the shape model can be interpreted as the linear hull of the feasible rigid-motion motions between W₁ and Wᵢ. FIG. 4 illustrates this rigid-body constraint applied to sparse subspace projection in 3-D.

Our algorithm of sparse shape subspace projection is described as follows. Given the observation W and a shape subspace V^{T}, the algorithm minimizes:

$${min}_{E , A} {‖ E ‖}_{1} subj . to {W}_{i} = {AV}^{T} + E . \qquad ( 12 )$$

By virtue of low dimensionality of this hull, together with the sparsity of the residual, the projected data AV^{T} should be well localized on the manifold. Hence, in addition to being consistent with a realistic (sparse) noise model, the new sparse subspace projection algorithm (12) also implies the benefit of good localization in the motion space.

The objective can be solved quite efficiently (and much faster than solving RPCA in the initialization) by the augmented Lagrangian approach:

$${min}_{A , E , Y , μ} {‖ E ‖}_{1} + 〈 Y , {W}_{i} - {AV}^{T} - E 〉 + \frac{μ}{2} {‖ {W}_{i} - {AV}^{T} - E ‖}_{F}^{2} , \qquad ( 13 )$$

where Y is a matrix of Lagrange multipliers, and μ>0 represents a monotonically increasing penalty parameter during the optimization. The optimization only involves a soft-thresholding function applied to the entries of E and matrix-matrix multiplication for the update of A and E, and does not involve computation of singular values as in RPCA.

Finally, the rigid-body motion between each Wᵢ and the first reference frame Wᵢ after the projection can be recovered by the OP algorithm (5). However, as the projection (12) may be also affected by dense Gaussian noise, the estimated low-rank component may not accurately represent a consistent rigid-body motion. As a result, what we can do is to identify an index set for those uncorrupted features with zero coefficients in E. The OP algorithm will be applied only using the uncorrupted original features in W₁ and Wᵢ. In a sense, this motion registration algorithm resembles the strategy in RANSAC to select inlying sample sets. However, our algorithm has the ability to directly identify the corrupted features via sparse subspace projection, and hence the process is noniterative and more efficient.

The complete algorithm, Sparse Online Low-rank projection and Outlier rejection (SOLO), is summarized in Algorithm 1.

Algorithm 1: SOLO

```
Input: Initial observations X, feature coordinates of the reference frame
W₁, and Wᵢ for each subsequent frame i.
  1: Init: Compute L and I of X via RPCA (7).
  2: W₁ ← W₁^{(I)}, remove outliers in the reference frame.
  3: [U,Σ,V] = svds(L^{(I)},4).
  4: for Each new onservation frame i do
  5:  Wᵢ ← Wᵢ^{(I)}.
  6:  Identify corruption E via sparse subspace projections (12).
  7:  Let Iᵢ be the index set of uncorrupted features in Wᵢ.
  8:  Estimate (Rᵢ,Tᵢ) using inlying samples in I_{I}∩Iᵢ.
  9: end for
Output: Inlier support set I, rigid-body motions (Rᵢ,Tᵢ).
```

A straightforward yet elegant extension of the algorithm in the presence of missing data is possible. In the initialization step, one can rely on a variant of RPCA to recover the missing data in matrix X The technique is known as low-rank matrix completion, which minimizes a similar low-rank representation objective constrained on the observable coefficients:

$${min}_{L , E} {‖ L ‖}_{*} + λ {‖ E ‖}_{1} subj . to {𝒫}_{Ω} ( L + E ) = {𝒫}_{Ω} ( X ) , \qquad ( 14 )$$

where Ω is an index set of those features that remain visible in X, and P is the orthogonal projection onto the linear space of matrices supported on Ω.

Using low-rank matrix completion (14), in the presence of a partial measurement of new feature tracks, those incomplete new observations should be identified as tracks with missing data. Then a new initialization step using (14) should be performed on a new data matrix X that includes the new tracks to re-establish the shape subspace and inlier support set I as in (9).

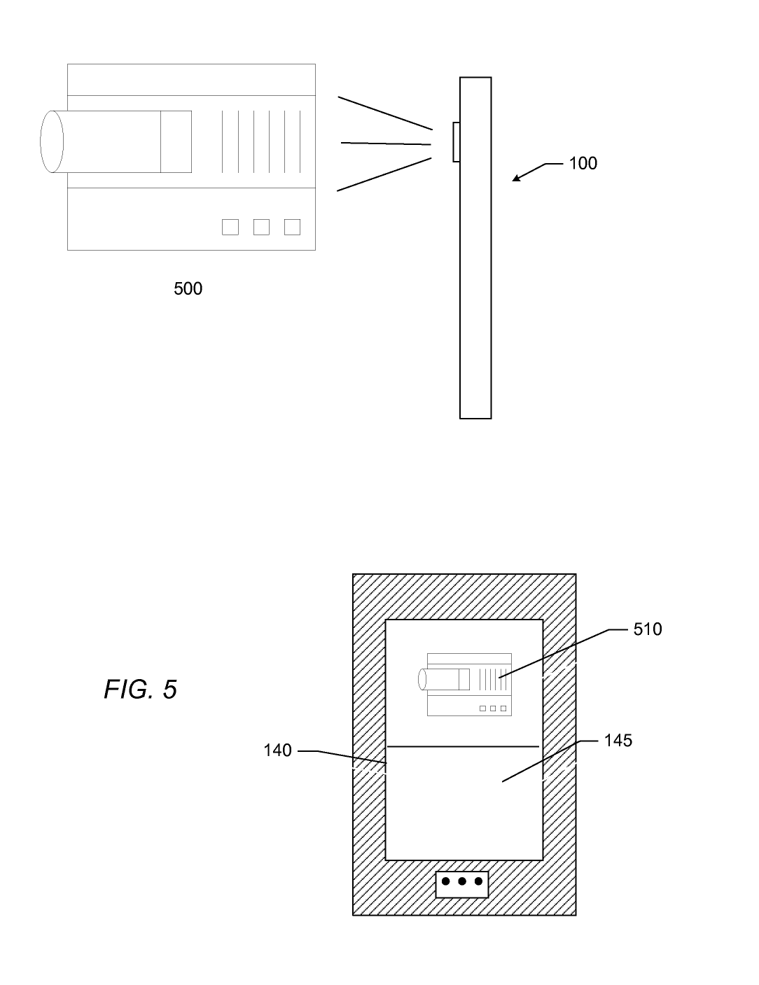

A display device 140 is coupled to processor and the body. In an embodiment, the three dimensional representation generated by the processor is displayed on the display device (see FIG. 5). In one embodiment, the body comprises a front surface 110 and an opposing rear surface 112. An image capture device 120 is coupled to the front surface of the body, and a display screen 140 is coupled to the rear surface of the body (as shown in FIG. 1B). The display device may be any suitable display. In some embodiments, the display device may be an LCD screen. The display device may be a touch screen display that accepts user input for the operation of the imagining device. In some embodiments, the processor provides a graphic user interface for the user 145, which is displayed on display screen 140 (See FIG. 5). The graphic user interface allows the user to operate the imaging device and manipulate the three dimensional representation. In another embodiment, on or more control buttons 160 may be coupled to the exterior of the body. Control buttons 160 may be used to provide commands to operate the imaging device and manipulate the three dimensional representation.

The imaging device may perform a variety of operations including real time object modeling, real time environmental modeling, and motion capture. In real time object modeling the processor is capable of displaying the generated three dimensional representation of the object or living subject being modeled substantially simultaneously as data is collected by the imaging device. In environmental modeling the processor is capable of capturing and creating a three dimensional representation of the environment as the camera is panned over the environment. The processor is also capable of recording the motion of a target and producing a video of the target. In some embodiments, the processor is capable of recording the motion of a living subject and converting the recorded motion into a wireframe model which is capable of movement mimicking the recorded motion.

In an embodiment, a method of generating a multidimensional representation of an environment includes: collecting images of an environment using an imaging device as described above. Distances from the image capture device to one or more regions of the environment are also collected. The collected environmental information is passed to a processor that prepares a three dimensional representation of the environment. The three dimensional representation of the environment is displayed on the display device. Collecting the image information and distance information of the environment, may, in some embodiments, be performed panning the imaging device over the environment. As the camera is panned over the environment, the three dimensional representation of the environment is substantially simultaneously generated. The position of the imaging device within the environment is determined by comparing information collected by the imaging device to the generated three dimensional representation of the environment. As the imaging device is panned, the three dimensional representation of the environment is extended to include new areas that move into the field of view of the imaging device. The three dimensional representation may also be refined during panning When the imaging device is moved to a region of the environment that is a part of the already generated three dimensional representation, the details may be refined by comparing the new data with the previous data. In this way noise can be reduced from the three dimensional representation.

FIG. 5 depicts a schematic diagram of imaging of a target. In an embodiment, a method of generating a multidimensional representation of a target includes: collecting images of a target 500 using an imaging device 100 as described above. Distances from the image capture device to one or more regions of the target are also collected. The collected target information is passed to a processor that prepares a three dimensional representation of the target 510. The three dimensional representation of the target is displayed on the display device 140. The target may be an inanimate object or a living subject. Collecting the image information and distance information of the target, may, in some embodiments, be performed by moving the imaging device around the target. As the camera is moved around the target, the three dimensional representation of the target is substantially simultaneously generated. The position of the imaging device with respect to the target is determined by comparing information collected by the imaging device to the generated three dimensional representation of the target. As the imaging device is moved around the target, the three dimensional representation of the target is extended to include new areas that move into the field of view of the imaging device. The three dimensional representation may also be refined during scanning When the imaging device is moved to a region of the target that is a part of the already generated three dimensional representation, the details may be refined by comparing the new data with the previous data. In this way noise can be reduced from the three dimensional representation.

In an embodiment, a method of capturing motion of a moving subject, includes collecting images of the moving subject using an imaging device as described above. Distances from the image capture device to one or more regions of the moving subject are also collected. The collected target information is passed to a processor that prepares a video of the moving subject. The processor also generates a wireframe representation of the moving target. As used herein a wireframe representation is a visual presentation of a three dimensional or physical object created by connecting an object's constituent vertices using straight lines or curves. The vertices of a moving subject are generally set at joints of the subject. The video of the moving subject is displayed on the display device. The displayed video also includes the wireframe representation superimposed over images of the moving subject displayed in the video.

In one embodiment, the imaging device is held in a substantially stationary position as the images and distance information of the moving subject is collected. In an embodiment, the imaging device is moved around the moving subject as the images and distance information of the moving subject is collected. The wireframe representation may be a three dimensional representation of the moving subject. When collecting the data, the wireframe representation is substantially simultaneously generated.

### Geographical Location Determination Using Three Dimensional Rendering of the Environment

In an embodiment, a method of determining the geographical location of a mobile device, includes collecting images of an environment using a mobile device, the mobile device comprising: a body; an image capture device coupled to the body; and a processor coupled to the image capture device and disposed in the body. The method includes collecting a distance of from the image capture device to one or more regions of the environment and generating, using a processor, a three dimensional representation of the environment. To determine the location of the mobile device, the generated three dimensional representation of the environment is compared to a graphical database comprising three dimensional representations of a plurality of environments at a plurality of known locations. The geographical location of the mobile device, and thus the user, may be determined based on the comparison of the three dimensional representation of the environment to environments in the graphical database. The mobile device may include a display screen. In an embodiment, the three dimensional representation of the environment is displayed on the display device. The display device may also display a map image, and the location of the mobile device may be indicated on the map image. As discussed below a graphical database may be stored on the mobile device, or may be accessible over a telecommunications network or a Wi-Fi network. In some embodiments, the graphical database, whether stored on the remote device or in a networked computer, may be limited to an area where the mobile device is expected to be used.

In one embodiment, a unified solution to mapping, localization, and visualization tasks is enabled in a visual capture device. Such a device may be useful in manned and unmanned applications. In an embodiment, methods and systems described herein may be used that uses visual odometry, mapping, localization on maps, and immersive visualization in a holistic, fully distributed framework. Furthermore, these methods and systems are compatible with a wide range of computational, power, and mobility constraints. Presenting a unified architecture for these key tasks will allow degrees of reliability, coverage, and utilization that exceed existing systems.

The architecture leverages a distributed hierarchy of nodes of three categories: (1) producer nodes, which perform relative localization and local mapping; (2) server nodes, which combine the measurements of tracking nodes into globally consistent maps; and (3) consumer nodes, which query the servers for visualization and absolute localization tasks. Producer nodes combine two emerging technologies, video-motion capture sensors and embedded GPGPU hardware, to provide optimized fidelity and acquisition rates. The server architecture is scalable and capable of interfacing with a variety of acquisition assets and usage cases. In further embodiments, methods are described for querying mapping assets by consumer nodes, including absolute localization from image queries and networked visualization. These features require no specialized imaging hardware and take into account the computational and bandwidth constraints of portable electronic devices.

In one embodiment, the method and system may be used to heighten the situational awareness of military forces in various environments and GPS-denied regions. In these situations, the need for alternative approaches to geo-referenced mapping and localization assets is necessary. The last decade has seen a boom in the development and deployment of new imaging systems, semi-autonomous robots, UAV's, MAV's and UGV's. While these systems offer adequate versatility and coordination, several issues remain. First, each of these technologies fails in one of the key categories of power, weight and cost. Second, unified software architecture for combining distributing sensing data into an environmental representation does not appear to exist. Third, these systems have difficulty with rapid dissemination of data, visualization of textured maps, or performing localization from low-cost sensing devices such as cell phones. Our methods and systems address each of these problems directly.

Our methods and systems represent a significant technical innovation leveraging all relevant modern technological trends. Producer nodes combine high data-rate emerging commercial off-the-shelf (COTS) sensors with general purpose floating point processors to provide high-fidelity map segments to the server in real time. Furthermore, innovative use of distributed processing in these nodes will reduce uplink bandwidths to levels permissive of rapidly evolving urban environments. The server architecture will combine the maps into a globally consistent, geo-referenced representation of the environment. By combining multiple data sources, the server-local map will achieve consistency and coverage much faster than an individual mobile mapping asset alone.

In one embodiment, the described method and system may be used for creating 3D representations of an area of military interest. Current systems available to military personnel are very high in data content but very low in information content—a diverse array of sensors collect massive quantities of data in terms of point clouds and multimodal measurements, whereas military personnel need succinct and immediate information on what objects are around them and what the objects are doing. This bridge between raw data and complete situational awareness is offered by our technology, converting huge volumes of data into intuitive 3D representations and an immersive visualization of the area of interest.

3D representations and immersive visualization has tremendous value in military tactical operations and missions. Visualization of structures, together with terrain-mapping play a central role in situational awareness for military personnel, which is essential for neutralizing resistance while curtailing casualties. This situational awareness must be provided in a rapid, easy-to-understand fashion that enables soldiers to make accurate and timely decisions on their course of action. It must also enable the military personnel to quickly identify and easily track anomalous entities and share this information with other military personnel.

In most conventional systems, a critical aspect of rendering and immersive visualization is location awareness. Without a dependable localization mechanism, rendering and visualization algorithms can prove ineffective. GPS, the traditional asset for localization, is widely known to be unreliable, and, in many cases, to be completely absent, for example in steep terrains and urban canyons. Moreover, GPS duping and spoofing can wreak havoc on any system that depends on it. In view of this, our methods and systems are designed to operate in the absence of GPS, thus going well beyond the capabilities of GPS dependent methods and systems.

In one embodiment, a method and system that uses a general absolute localization framework includes:
1. An online graphical database for storing landmarks on a map. The database will support insertions and removals; passive staleness and reproducibility statistics; and extremely low complexity landmark queries.
2. The positional decoder for absolute localization. The positional decoder will support arbitrary features and landmarks by design and support two optimization modes: maximum likelihood estimation and a robust convex relaxation. The maximum likelihood variant is based on a Viterbi decoder, producing a statistically interpretable result with error bounds. The convex relaxation will replace the Viterbi decoder with a convex optimization framework that naturally compensates for corrupted and missing data via L1 minimization.

Estimation techniques, such as Kalman filters (KFs), extended Kalman filters (EKFs), or particle filters (PFs) are used to ascertain first-orders statistics from measurements at higher orders. Because measurement integration is inherent in these frameworks, drift error is a major problem, and with large outage windows, the error grows quadratically.

Several absolute localization methods exist to overcome drift error. Unfortunately, these techniques are either limited in scope or require expensive supporting infrastructure. GPS is perhaps the best known and most commonly used absolute localization scheme. In the absence of reliable GPS, pseudolite infrastructure may be deployed; however, pseudolites are victim to many of these same effects that incur GPS outages and themselves must be absolutely localized for reliable results. Altimeters are a reliable zero moment sensor but do not provide a sufficiently high accuracy for localization at ground level, and even with expensive altimeters the ground topography must be sufficiently contour-salient and known in advance. Magnetometers are extremely noisy and require intricate knowledge of (possibly time-varying) magnetic fields in the operating environment.

Statistical estimation tools are a popular technique to extend (estimation) and combine (sensor fusion) the measurements of the above devices. Because statistical estimation requires only proper modeling of the covariance statistics of the sensors, they are quite extensible to a range of measurements including zero-moment readings. However, estimators cannot overcome the fundamental limitations of these devices such as inevitable drift error in relative sensors or the high cost of absolute localization. We note that statistical estimators are extensible to the zero-moment information provided by our positional decoding algorithm and extremely well established. These estimation techniques may be incorporated into our estimation framework.

Our method to absolute localization builds on several techniques that gained popularity during the development of SLAM systems over the past decade. Viewpoint registration and data association are of particular relevance since they provide visual-assisted relative localization and absolute localization in SLAM systems, respectively.

Viewpoint registration, also known as visual odometry, is the process of obtaining a relative motion estimate by analyzing sequences of visual observations. Viewpoint registration can work with a range of optoelectronic sensor modalities including video (producing a graph of fundamental matrices or a sparse bundle) or range data (producing a graph of Euclidean displacements). Typical algorithmic solutions include RANSAC the eight-point algorithm, ICP, and sparse bundle adjustment. In the context of mobile agent localization, viewpoint registration is the optoelectronic analogue of an iterative state estimator.

Data association is a set of competing approaches for relating observations to a known map. Perhaps the most well-known is the bag-of-words (BoW) approach, which computes a vector representation of local invariant features and compares frames via the cosine distance. False positive associations are rejected by a spatial consistency check such as the Hough transform or random sample consensus. Notably, data association in SLAM is used for loop closures and is geared towards producing a temporally sparse set of true positive associations. Furthermore, data association is highly reliant on visually salient views dense in features for both reliable association and the spatial consistency check. Hence these techniques are poorly suited for online absolute localization in potentially feature-denied environments. In SLAM, data association serves an absolute localization purpose similar to global or pseudolite GPS.

Though related to both of these techniques, our positional decoding framework is actually an extension beyond these techniques specifically targeted at absolute localization. Furthermore, it functions fully independent of SLAM given a mapping asset. Our framework provides relative and absolute localization from a variety of data sources by analyzing the sequence of sensor measurements for a feasible motion path; further, the trajectory is anchored in global geometry by decoding where on the map this motion path exists. Our method includes a technology asset which exceeds the basic requirements and capabilities of a SLAM-based localization system, provides provable guarantees on asymptotic performance, and is in fact fully independent of the choice of mapping system.

Coding theory is a discipline that covers a wide spectrum of topics. The key to coding is the presence of a controlled amount of redundancy, which enables the recovery of the original source, even in the presence of noise and/or quantization error. Given the versatility of coding theory, it has found applications in multiple disciplines—in communication over noisy channels, in compression of sources, in secrecy and security for information transmission and many others.

There are multiple families of codes, with algebraic & geometric structure, that have been devised with polynomial time encoding and decoding algorithms. The most practically used class among these is convolutional codes, used in CDs & DVDs, the Ethernet, wireless communication systems and many others. Convolutional codes are encoded and decoded in polynomial-time using the well-known Viterbi decoding algorithm (a dynamic programming algorithm). The convolutional code structure affords a highly efficient trellis representation for the code (a significant state space collapse) which, turn, results in a high efficient encoding and decoding structure in use today.

The optimal decoding of convolutional codes, or for that matter, of any code, can be understood as a maximum likelihood (ML) hypothesis test. In his pioneering work, Feldman casts ML decoding of an arbitrary linear code as an integer linear program (LP) over a convex set, and uses a relaxed LP formulation to present a decoding algorithm for any code. Since this work, linear programming based decoders have been developed for multiple classes of codes, including LDPC codes as well as conventional block codes such as Reed Solomon codes. Such a reformulation of the problem casts decoding in the light of convex optimization, and optimization tools and techniques can be used to perform decoding. Moreover, the optimization problem can now be modified and constrained to include additional requirements, including regularization, sparsity and smoothness and other constraints. Regardless of the nature of the constraint, convex optimization tools such as interior-point (or primary-dual distributed algorithms) can be used to solve the problem in real-time.

The methods and systems use absolute localization on a variety of different mapping assets. This may be accomplished by using: (1) a flexible database of landmarks which capacitates fast lookups and (2) a positional decoder to recover location from a sequence of position hypotheses. The specific features of this method include:
1. A feature-based similarity engine for a variety of visual and shape descriptors. The similarity engine enables constant complexity lookups from a database of landmark locations.
2. The feature pools are combined in a single graph framework, which supports arbitrary environment topologies and provides statistical transition likelihoods to the decoder.
3. A maximum likelihood decoder capable of recovering the correct location of a mobile agent when features are abundant (no missing data).
4. The decoder is generalized to a relaxed convex program that handles missing data, featureless spaces, and noisy database queries.

### 1. Similarity Engines

The positional decoder is designed to recover the correct location of a mobile agent given several candidate locations from a known map. While the decoder is highly efficient by design, it requires an input set of position hypotheses. These hypotheses are the product of a similarity engine, a database for relating observed visual content to a known set of landmarks and features. While similarity engines are highly established assets in the computer vision community, absolute localization on (possibly large) known maps imposes stringent requirements on speed and accuracy. Furthermore, the localization system supports a variety of 2D (optics) and 3D (LIDAR/stereo) features for flexibility towards a variety of usage cases.

A general similarity engine may be used with arbitrary features for which the cosine similarity measure is meaningful. These include SIFT, SURF, and random forest-based 2D features as well as emerging 3D features such as the fast point feature histogram. These features allow robust similarity indexing for visible spectrum- and IR-based optoelectronics as well as LIDAR and active stereo.

Furthermore the localization or mapping system is capable of providing constant complexity data association. This may be achieved by using hashing schemes, particularly locality sensitive hashing with p-stable distributions. The method combines efficient hash functions with a fast inverse indexing scheme to produce data association in constant expected time.

### 2. Graphical Database

The positional decoding scheme operates on the principle that some sequences of measurements are more probable than others. This requires an explicit characterization of the underlying geometry of the landmarks (a map) as well as modeling of the likelihood of transitioning between various features. The most natural way to model this information is as a network of landmarks stored as a graph. In this graph, the vertices represent landmarks while the edges convey the transition likelihood, or nearness, of different landmarks.

This database works with a variety of different data sources including sparse, dense, and monocular simultaneous localization and mapping (SLAM); precompiled 3D and 2D maps; video streams combined via structure from motion (SfM) or data association; and more.

The database also is designed to exceed the requirements of the decoder with future applications in mind. Landmarks may be inserted and removed ad hoc, and landmark positions updated dynamically. The database supports passively computed statistics including landmark staleness and reproducible (observed by the decoder).

### 3. Maximum Likelihood Decoding

The decoder operates by refining the results of several consecutive similarity engine queries into a single “likely” trajectory describing both the localization and motion of the mobile agent. The simplest interpretation of “likely” is that consecutive observations be nearby. In coding parlance, the codebook is all physically feasible observation trajectories. Though this codebook is naturally enormous, the decoder need not explicitly characterize it. The ML decoder make use of well-established dynamic programming techniques to overcome the problem size and achieve real time results.

The ML decoder maximizes a transition likelihood function over all candidate trajectories produced by the similarity engine. Various functions can be used, with quadratic costs corresponding to maximum likelihood estimation under a Gaussian posterior assumption. The functional is separable over landmark-landmark transitions and has suboptimal structure by construction. Hence it can be solved in parallel using dynamic programming (e.g., Viterbi's algorithm). This algorithm has been used to obtain reliable, real time performance in millions of mobile telephony devices for over twenty years.

The maximum likelihood decoder is simple to implement and use and extensible to various cost functions depending on the application. The cost functions may be modified via odometric or IMU information as well to increase performance when those data sources are available. Furthermore, the results of the positional decoder may be fed back to the state estimation framework as non-sequential zero-moment measurements, allowing two-way compatibility with existing estimation sensors and assets.

### 4. Relaxed Convex Program

The above decoder is a combinatorial optimization problem with a convex objective. There are several approaches by which to relax this problem into a convex optimization problem. Relaxation of conventional block decoding can be carried out by linear programming techniques. The two primary advantages of convex relaxation are efficient techniques for solving intractable problems and robust extensions. Since dynamic programming offers a highly efficient and parallelizable approach to positional decoding, the focus of our convex programming extension rests primarily on robustness. Our convex solver offers many of the same guarantees as discussed above while providing robustness to featureless and sparse feature encodings of the mapping domain

Our convex relaxation framework exploits the joint position-visual information of landmarks on arbitrary maps. The maximum likelihood decoder produces absolute localization by exploiting the implicit smoothness of all feasible motion profiles. In the convex relaxation, the motion profile is modeled explicitly as a sequence of robot localizations. These sequences present as discrete trajectories of continuous latent variables in global geometry. Smoothness in the motion profile is guaranteed by regularizing transition costs. To ensure that the motion profile fits visual observations, an additional regularization term is added which penalizes latent variables far away from observed measurements. The above framework can be converted into a quadratically constrained quadratic program and solved efficiently with well-established techniques. The problem structure is also conducive to distributed solutions, which can be computed readily on multicore hardware.

The main advantage of the convex relaxation is its robust extensions. In practice, featureless observations, visual ambiguities, and hashing collisions often produce poor data association. These problems were previously mentioned as significant limitations of approaches utilizing data association alone. In a decoding framework, these missing or corrupted data terms lead to combinatorial optimization problems, which are highly intractable and often exhibit exponential complexity without special code structure. In a convex relaxation, however, these terms can be readily compensated via conventional L1 minimization techniques. Our convex solver follows this approach, introducing an L1-penalized missing data term.

Our system and method produces highly consistent interior maps as 3D representations. The maps are produced in real time at extremely high data rates. Output maps are stored in a proprietary data format, which can be interpreted in various ways. The high-fidelity representation exhibits a high reconstruction accuracy that can be visualized in OpenGL. Hence human operators can interpret the map intuitively. Since the high-resolution output maps are enormous (in the tens of gigabytes), the map can also be interpreted as a lightweight graph of visual landmarks, which can be stored on a mobile device. This mapping capability is an important prerequisite for optoelectronic absolute localization and represents a significant effort. Our maps produce all of the required information to prototype and evaluate the positional decoding strategy.

In some embodiments, a sophisticated constant complexity similarity engine for rapidly associating landmarks in a large database is used. Feature extraction techniques for visual and depth sensors are used. The extractors may be sourced from open source libraries including PCL and OpenCV. Our extractors support SIFT, SURF, and FPFH descriptors. Fast k-means implementations on the GPU are used for rapid vocabulary formation and histogramming. This represents an underdeveloped area in the literature, as most researchers consider vocabulary construction to be an “offline” system component.

A fast similarity indexing system based on locality sensitive hashing (LSH) may be used. The hashing cascade in the LSH framework is tuned to real world data using cross-validation, ensuring low collision and miss rates. The verified similarity engines may be combined in a graphical framework extensible to real world maps.

The verified similarity engines may be combined in a graphical framework extensible to real world maps. The graph is validated through integration with our SLAM system. At this point, the true and false positive rates (negatives are not relevant to our absolute localization goals) are verified in situ. This shows that:
1. The similarity engine is fast and efficient enough to be used in localization tasks in a running system.
2. The accuracy of data association with this framework is sufficient for positional decoding.

In addition to providing a foundation for positional decoding, the similarity engine provides a baseline implementation for absolute localization. The engine as described above will provide temporally sparse absolute localization results via data association, which is the current state of the art technique in SLAM. Positional decoding is expected to substantially improve the results of a similarity-based approach alone.

The feasibility of the maximum likelihood decoder may be studied in simulation. One simulation environment models the classification accuracy of the underlying similarity engine with parameters from experiments on our database. The successful decoder, in simulation, demonstrates the efficacy of the underlying framework in successfully recovering absolute localization while abstracting robustness issues necessitating significant further development.

In some embodiments, the maximum likelihood decoder is integrated with the similarity framework. Integration will allow an analysis of the effect of various regularizing cost functions on the inferred motion profile. Experimentation with convex objectives to maintain compatibility with the convex relaxation may be used to test the framework. In developing the maximum likelihood decoder, real time performance in feature-rich spaces is used for testing. The asymptotic behavior of the decoder is analyzed and provides statistical guarantees on performance as a function of environment saliency parameters. Maximum likelihood estimations with Gaussian posteriors to produce interoperability with Kalman filter-based state estimators that proliferate existing systems may be used.

Moving on the convex relaxation, the framework may be optimized, slowly transitioning features of the maximum likelihood estimator to convex solvers. This approach is used to confirm the validity of the convex framework and allow reuse of regression benchmarks developed for the maximum likelihood decoder. A convex solver may be developed as follows:
1. Substitution of dynamic programming iteration with sparse selection: The dynamic programming iteration can be reformulated as a linear program with standard techniques. This step is a relaxation of a combinatorial problem, so exact equivalence with the dynamic program cannot be guaranteed. Validation may consist of demonstrating equivalent results for a high (>95) percentile of benchmark queries.
2. Relaxation via latent variables: The maximum likelihood decoder features a continuous convex objective but a discrete domain with suboptimal structure. To convert the problem to a convex program, the domain is relaxed by substitution with continuous variables. Latent variables are introduced in global geometry at each time stamp and ensure consistency with the discrete alphabet via convex fitness functions. While this form of regularization can be expected to produce similar results as the discrete problem, it is extremely expensive. The complexity may be reduced by removing the discrete alphabet entirely.
3. Similarity-based regularization: A regularizing term is introduced to the convex objective reflecting the similarity of each observation to landmarks on the map. This regularization will preclude trivial solutions and register the motion profile to known landmarks. It will also solve the dimensionality issues introduced in Part 2. The regularizing term may be based on a simplex-based weighting of the landmarks on the map similar to the dual support vector machine.
4. Missing value compensation: The final feature of the convex program is a missing value compensation term. This term will compensate missing and corrupted data arising in any similarity-based localization system. Surrogate missing value terms may be introduced in both the position and visual optimization terms and couple them via a standard penalty. Sparsity will be enforced via standard L1 minimization. Since this milestone represents the main objective of the proposal, validation will be significantly more thorough, and both the simulation and real world data will be extended for sparse corruptions.

Our system is immediately compatible with modular unmanned ground vehicles like iRobot's 510 PackBot or Qinetiq Group's Dragon Runner. These robots are designed to be easily configurable depending on their objectives and would be well suited for a versatile localization solution such as ours. Positional decoding can also be a valuable asset to global mapping systems. As mapping has shown to be an invaluable asset to the military, especially for tasks such as IED detection as exemplified by the JIEDDO, we believe any improvements that our system would bring to previously developed mapping technologies would not only be worthwhile but key to the continued development of these defense systems.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. An imaging device comprising:
a body;
an image capture device coupled to the body, wherein the image capture device collects an image of a target or environment in a field of view and a distance from the image capture device to one or more features of the target or environment;
a processor coupled to the image capture device and disposed in the body, wherein the processor receives data from the image capture device and generates a three dimensional representation of the target or environment; and
a display device, coupled to the processor and the body, wherein the three dimensional representation is displayed on the display device.

2. The imaging device of claim 1, wherein the image capture device comprise sensors capable of collecting color information of the target, grayscale information of the target, depth information of the target, range of features of the target from the imaging device, or combinations thereof.

3. The imaging device of claim 1, wherein the image capture device is a range camera.

4. The imaging device of claim 1, wherein the image capture device is a structured light range camera.

5. The imaging device of claim 1, wherein the image capture device is a lidar imaging device.

6. The imaging device of claim 1, wherein the body comprises a front surface and an opposing rear surface and wherein the image capture device is coupled to the front surface of the body, and the display screen is coupled to the rear surface of the body.

7. The imaging device of claim 1, wherein the display screen is an LCD screen.

8. The imaging device of claim 1, wherein the processor is capable of generating the three dimensional representation of the target substantially simultaneously as data is collected by the imaging device.

9. The imaging device of claim 1, wherein the processor is capable of displaying the generated three dimensional representation of the target substantially simultaneously as data is collected by the imaging device.

10. The imaging device of claim 1, wherein the processor provides a graphic user interface for the user, wherein the graphic user interface allows the user to operate the imaging device and manipulate the three dimensional representation.

11. The imaging device of claim 1, wherein the processor is capable of capturing the motion of a target and producing a video of the target.

12. The imaging device of claim 1, wherein the processor is capable of capturing the motion of a living subject and converting the captured motion into a wireframe model which is capable of movement mimicking the captured motion.

13. The imaging device of claim 1, wherein the three dimensional representation of the target comprises color, shape and motion of the target.

14. A method of generating a multidimensional representation of an environment, comprising:
collecting images of an environment using an imaging device, the imaging device comprising:
a body;
an image capture device coupled to the body;
a processor coupled to the image capture device and disposed in the body; and
a display device, coupled to the processor and the body
collecting a distance from the image capture device to one or more regions of the environment;
generating, using the processor, a three dimensional representation of the environment; and
displaying the three dimensional representation of the environment on the display device.

15. The method of claim 14, wherein collecting image information and distance information of the environment is performed by palming the imaging device over the environment.

16. The method of claim 14, further comprising:
substantially simultaneously generating the three dimensional representation of the environment as the data is collected by the imaging device; and
determining the position of the imaging device within the environment by comparing information collected by the imaging device to the generated three dimensional representation of the environment.

17. The method of claim 16, further comprising extending the generated three dimensional representation of the environment as the imaging device is moved to areas of the environment not previously captured.

18. The method of claim 16, further comprising refining the generated three dimensional representation of the environment when the imaging device is moved to a region of the environment that is a part of the generated three dimensional representation.

19-25. (canceled)

26. A method of generating a multidimensional representation of a target, comprising:
collecting images of the target using an imaging device, the imaging device comprising:
a body;
an image capture device coupled to the body;
a processor coupled to the image capture device and disposed in the body; and
a display device, coupled to the processor and the body
collecting a distance from the image capture device to one or more regions of the target;
generating, using the processor, a three dimensional representation of the target; and
displaying the three dimensional representation of the target on the display device.

27-60. (canceled)
